(19) United States
(12) Patent Application Publication
(10) Pub. No.: US 2011/0057020 A1
(43) Pub. Date: Mar. 10, 2011

(54) Talking picture postcard

(76) Inventor: Charles Russ Colby, Marina del Rey, CA (US)

(21) Appl. No.: 12/584,586

(22) Filed: Sep. 9, 2009

(51) Int. Cl. B42D 15/02

(52) U.S. Cl. 229/92.8

(57) ABSTRACT

A talking picture postcard with a scored and die cut paperboard or thin plastic panel having a central portion, a first portion, a picture frame portion and a second portion which when folded together form a rectangular postcard sized construction. Within the folded construction is an audio microprocessor and support electronics. One side of the paperboard construction includes a die cut picture frame and the other side includes removable graphic labels that give instructions to the user on how to make a recording. When the user completes the recording he removes the graphic labels and pushes down on a record switch separator tab so that the receiver can not accidentally record over the message. The user can insert a photo or other graphic into the picture frame portion and then send the entire unit through the mail just as one would send a standard postcard.

### STATEMENT REGARDING FEDERALLY SPONSORED RESEARCH OR DEVELOPMENT

Not Applicable

### CROSS REFERENCE TO RELATED APPLICATIONS

Not Applicable

### DESCRIPTION OF ATTACHED APPENDIX

Not Applicable

### BACKGROUND OF THE INVENTION

This invention relates generally to the field of mailable postcards and more specifically to talking picture postcard.

Postcards are well known the world over and are a common way for people to send a quick message and a photo or other graphic image to friends and family.

Postcards come in a variety of sizes and shapes but are usually rectangular and small enough to be processed through standard postal mail carrying means. Small audio record and playback microprocessor chips have also become popular recently and have been used in greeting cards, so that when the user opens the card, a pre-recorded message or song is played. Some cards include the ability to record a message that can be played back by the recipient. However, none of the prior art has addressed the possibility of producing a recorded message within a post card sized device so that the user can insert a graphic image or his or her choice into a slot within the postcard structure while insuring that the receiver of the card can not accidentally record over the message.

### BRIEF SUMMARY OF THE INVENTION

The primary object of the invention is to provide a postcard sized device that includes a slot for inserting a photo or other graphic.

Another object of the invention is to provide a postcard sized device that includes an audio record and playback feature.

Another object of the invention is to provide a talking postcard whose audio message can not be accidentally erased or by the receiver.

Another object of the invention is to provide a talking postcard that has a built in easel back to that the card may be set on a flat surface in an upright position.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed talking picture postcard comprising: a scored and die cut paperboard panel having a central portion, a first portion, a picture frame portion and a second portion which when folded together form a rectangular postcard sized construction. A transparent panel covers the picture frame portion. A plurality of electronic audio producing components include a battery power supply, a speaker, an audio record and playback microprocessor, a microprocessor PCB, a record switch contact PCB, a record switch contact metal strip, a removable contact separator tab, a record switch, a microphone, a playback switch and an LED. A removable recording instruction label, a removable label including a graphic record button, mic locator circle and led locator help the user make an audio recording. A die cut foam filler panel protects the enclosed electronics. said audio microprocessor PCB supporting said audio components The microprocessor PCB is centrally mounted on said central paperboard panel. The speaker is mounted to one side of said microprocessor PCB on said central paperboard panel. The recording contact PCB is mounted on the upper portion of said central paperboard panel. The slidable record switch contact separator tab is located between a pair of electrical contacts located on said recording contact PCB. A recording switch contact metal strip makes contact with the record switch contacts when the separator tab is slid upwards. Said record switch, said LED said microphone and said playback switch are all mounted in a row on the lower portion of said central paperboard panel, Said foam filler panel is die cut and attached to said central paperboard panel so that said foam filler panel surrounds said electronic components and extends to fill said central panel to help form a rectangular postcard sized shape. said first portion of said paperboard panel folding over to completely cover and adhere to said foam panel, said picture frame portion of said paperboard panel is covered by a transparent sheet and then folded over to cover said central paperboard portion forming an open slot between said central portion and said picture frame portion. Said second paperboard portion folded over and adhered to the back side of said central portion. The outside of said second portion forming the back side of said talking picture post card and including a permanent printed graphic of a “play” button. The back side of said second portion including said removable instruction label and said removable “record”, “mic” and “LED” graphic label, so that when a user slides up the contact separator tab and presses said record graphic button said user can record an audio message for the receiver of said postcard and then completely slide down said contact separator and remove said graphic label and said instruction label so that said record switch location is no longer apparent. Said user can then slide a photo or other graphic panel into said slot the side of said paperboard rectangular construction so that it appears through said transparent panel and then mail the talking picture postcard of the present invention through standard mail delivery means.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective front view of the invention.

FIG. 2 is a rear plan view of the invention.

FIG. 3 is a top plan view of the invention in the unfolded state.

FIG. 4 is a rear plan view of the invention supported by a built in easel.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

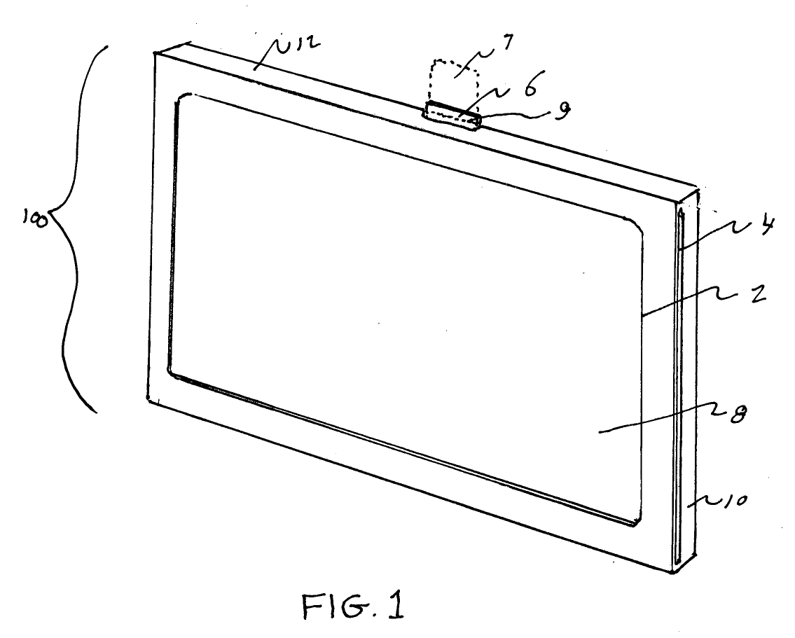

Referring now to FIG. 1 we see a front perspective view of the talking picture postcard of the present invention 100. The construction of the device 100 is made of die cut and folded paperboard to form a rectangular postcard sized structure. However, thin die cut plastic sheet may also be used. A front panel 2 has a die cut portion forming a picture frame. The central portion within the frame is covered by a transparent panel 8 preferably made of thin transparent plastic such as vinyl or acrylic or styrene which is adhered to the sides of the frame panel 2. A slot 4 on the side 10 of the rectangular postcard sized structure can accept a photograph or other graphic of the user's choosing including a standard flat picture postcard such as the type found in souvenir and gift shops worldwide. A tab 6 can be raised as shown by dotted line 7 to allow recording activity. Tab 6 can then be lowered as shown in dotted line 9 after an audio message has been recorded by the user. Because tab 6 is almost flush with the postcard side 12, the receiver of the card can not lift the tab 6 to accidentally record over the sent message. This tab 6 is a separator that keeps the internal electrical contacts from touching a metal contact strip thereby preventing or allowing recording activity as will be described more fully below.

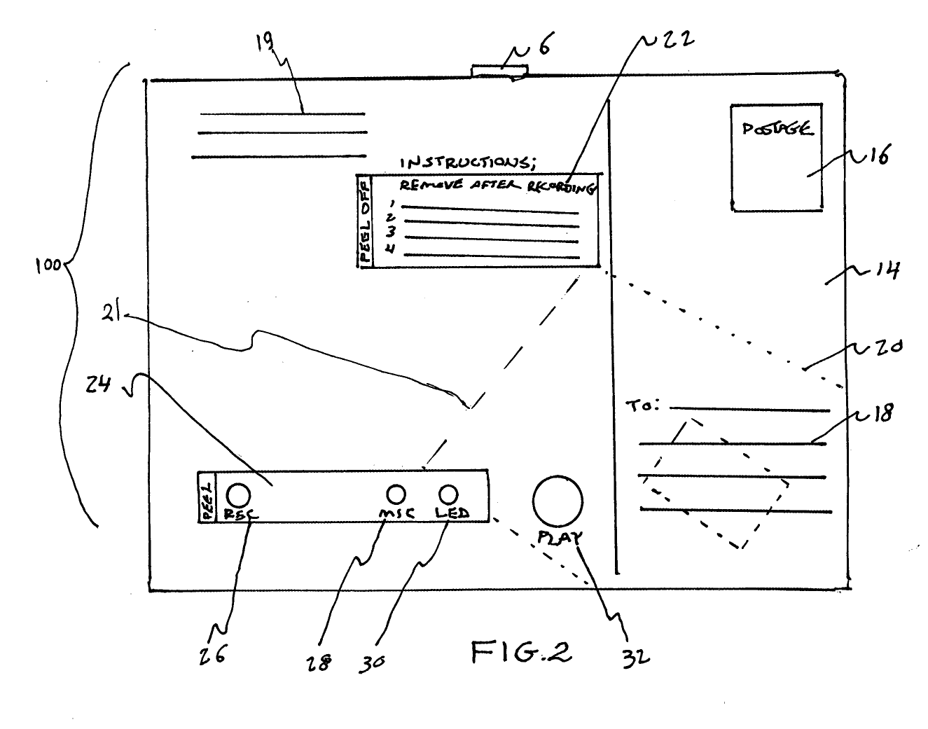

FIG. 2 shows a rear plan view of the invention 100. This view shows the back surface 14 of the talking picture postcard 100. The back 14 is flat and includes printed graphics such as a postage frame 16, receiver's address lines 18 and sender's address lines 19 as well as a graphic “play” button 32. Also found on the back panel 14 are two removable labels 24, 22. One label 22 includes instructions for recording a message. The instructions are as follows:

### “Remove After Recording”

“1. To record, pull the tab above until fully extended. Then press and hold the “REC” button while speaking into the ‘MIC”. Record up to ten seconds while red LED is on.”
“2. Press play button to listen.”
“3. To re-record, repeat steps 1 and 2.”
“4. Once satisfied, push tab above completely down to lock message.” The second label 24 includes graphic buttons for “REC” 26 “MIC” 28 and “LED” 30.

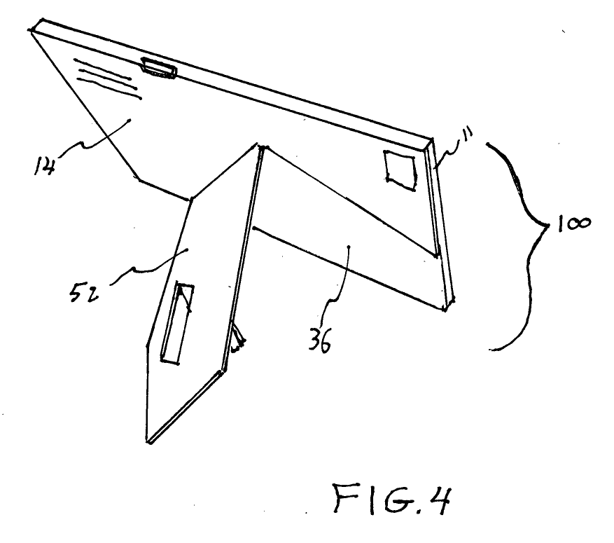

While the user is making a recording the LED light turns on as a visual indicator that a recording is taking place After the user finishes the recording he is instructed to remove this label 24 so that the receiver does not know where the record switch is and therefore is less likely to accidentally press it. The only graphic the receiver sees is the “PLAY” button 32 which is permanently printed on panel 14. Perforated lines 20 and score line 21 show where the receiver can separate a portion of the back panel 14 to form an easel back so that the postcard may be set up like a standard picture frame as shown in FIG. 4.

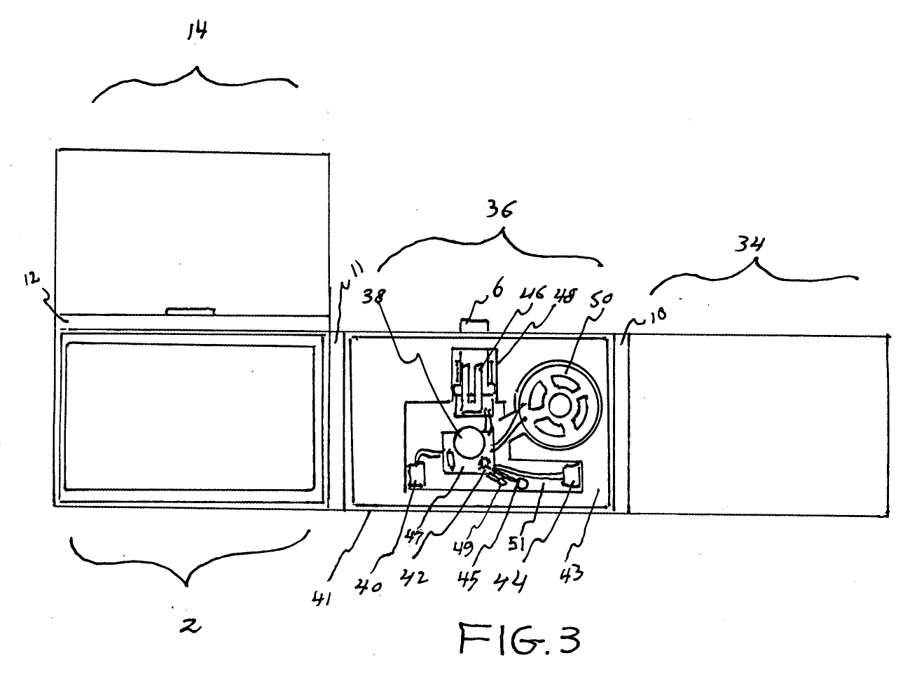

FIG. 3 shows a plan view of the unfolded version of the present invention 100. A central portion 41 supports a PCB 47 that in turn supports a standard audio record and playback microprocessor 42 as well as a battery power supply 38 and other standard electronic components. An audio speaker 50 is attached to the central portion 41 to the right of the audio PCB 42. A record prevent switch is created by paperboard tab 6 being sandwiched between a metal contact 46 and a pair of mating contacts located under tab 46 which are supported by switch contact PCB 48. Playback switch 40, LED 49, Microphone 45 and record switch 44 are placed in a row on the lower portion of central panel 41 and align with the graphic buttons on the back of paperboard panel 14. A resilient foam sheet 43 is die cut to allow room for all electronic components. The sheet 43 acts as a filler and is approximately one quarter of an inch thick, although thinner versions are anticipated as the thickness of the electronic components decreases. Since all electronic components shown are less than one quarter of an inch thick, a smooth flat surface is formed when first paperboard portion 34 and side wall 10 are folded over and adhered to foam sheet 43. The picture frame portion 2 and side wall 11 are then folded over and adhered to first paperboard portion 34. Finally the second paperboard portion 14 and side wall 12 are folded over the back wall of central portion 41 and adhered. The complete rectangular talking picture postcard is now ready for use. The thin profile and standard postcard size allow the invention 100 to travel easily through postal handling systems throughout the world and to arrive safely to the surprise and delight of the recipient. An alternate embodiment includes a talking picture postcard having a pre recorded message so that there would be no need for the user to record a custom message.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. talking picture postcard comprising:
a scored and die cut sheet panel that can be folded to form a rectangular postcard sized structure having an approximate thickness of one quarter of an inch;
said structure enclosing an audio microprocessor circuit and other standard components necessary to record and playback an audio message;
said structure including a picture frame front portion and transparent covering sheet portion;
said structure including a slot that allows a user to insert a graphic panel of his or her choosing so that said graphic can be seen behind said transparent portion.

2. talking picture postcard as claimed in claim 1 wherein said die cut sheet panel is a scored and die cut paperboard panel having a central portion, a first portion, a second portion and a picture frame portion which when folded together form a rectangular postcard sized construction;

3. Talking picture postcard as claimed in claim 1 wherein said electronic audio components include;
a battery power supply;
a speaker;
an audio record and playback microprocessor;
a microprocessor PCB;
a record switch contact PCB;
a microprocessor PCB
a record switch contact metal strip;
a slidable recording switch contact separator tab;
a record switch;
a microphone;
a playback switch;
an LED that lights during recording activity;

4. Talking picture frame as claimed in claim 1 wherein the back panel of said postcard structure includes a removable recording instruction label; a removable label including a graphic record button, mic locator circle and an led locator.

5. Talking picture frame as claimed in claim 1 wherein said postcard structure includes within it a die cut foam filler panel surrounding said audio microprocessor PCB supporting said audio components.

6. Talking picture frame as claimed in claim 1 wherein said microprocessor PCB is centrally mounted on a central portion of said sheet panel;
said speaker mounted to one side of said microprocessor PCB on said central portion
said record switch contact PCB mounted on the upper portion of said central portion;
and said slidable recording switch contact separator tab located between a pair of electronic contacts located on said record switch contact PCB and said record switch contact metal strip;
said record switch, said LED said microphone and said playback switch all mounted in a row on the lower portion of said central paperboard panel;
and extends to fill said central panel to form a rectangular postcard sized shape;

7. Talking picture postcard as claimed in claim 1 wherein a first portion of said sheet panel folds over to completely cover and adhere to said foam panel;
said picture frame portion of said sheet panel die cut into a picture frame shape;
said picture frame portion covered with said transparent panel;
said picture frame portion and said transparent panel folded over to cover said central sheet portion forming an open slot between said central portion and said picture frame portion;
a second sheet portion of said sheet panel folded over and adhered to said picture frame portion;
the outside of said second portion forming the back side of said talking picture post card and including a permanent printed graphic of a “play” button;
said back side of said second portion also including said removable instruction label and said removable “record”, “mic” and “LED” graphic label;
so that when a user slides up said recording contact separator tab and presses said record graphic button said user can record an audio message for the receiver of said postcard and then slide down said separator tab and remove said graphic label and said instruction label so that said record switch location is no longer apparent; and
and said user can slide a photo or other graphic panel into said slot the side of said paperboard rectangular construction so that it appears through said transparent panel.

8. Talking picture postcard as claimed in claim 1 wherein said second paperboard portion includes a score line and perforated tear lines to allow the receiver of said talking postcard to reposition a portion of said third panel to form a support easel.

9. Talking picture postcard as claimed in claim 1 wherein when the receiver of said talking picture postcard presses said “play” button graphic on the back side of said second paperboard portion, he or she will hear said user's recorded message and will not easily be able to accidentally record over said user's message because said “record” button graphic and said instruction label are no longer attached to the back of said second paperboard portion and said record switch separator tab is completely pushed in and flush with said paperboard construction making recording impossible.

10. Talking picture postcard as claimed in claim 1 wherein said audio message is pre recorded.
